(19) United States
(12) Patent Application Publication
(10) Pub. No.: US 2016/0012521 A1
(43) Pub. Date: Jan. 14, 2016

(54) System and Method for Online Bidding

(71) Applicant: BidAway, Inc., Barcelona (ES)

(72) Inventor: Luca Carlucci, Barcelona (ES)

(73) Assignee: BidAway, Inc., Barcelona (ES)

(21) Appl. No.: 14/789,931

(22) Filed: Jul. 1, 2015

Related U.S. Application Data
(60) Provisional application No. 62/023,722, filed on Jul. 11, 2014.

(51) Int. Cl. G06Q 30/08; G06Q 10/02

(52) U.S. Cl. CPC G06Q 30/08; G06Q 10/02

(57) ABSTRACT

A system and method for online bidding is disclosed. According to one embodiment, a computer-implemented method by a server includes receiving an available number of units of an offered item for bidding in an online auction from one of an inventory provider and a database, receiving a first bid price for the offered item from a first user account on a first user device, providing an indication to the first user account to purchase a first unit at the first bid price, determining a remaining number of units from the available number of units, receiving a second bid price for the offered item from a second user account on a second user device, and providing an indication to the second user account to purchase a second unit at the second bid price based on the second bid price greater than the first bid price by at least a minimum bid step, and based on the remaining number of units.

### CROSS REFERENCE TO RELATED APPLICATIONS

The present application claims priority to U.S. Provisional Patent Application No. 62/023,722 entitled “SYSTEM AND METHOD FOR ONLINE BIDDING” filed on Jul. 11, 2014, which is hereby incorporated by reference.

### FIELD

The present disclosure relates in general to online auctions. In particular, the present disclosure relates to a system and method for online bidding.

### BACKGROUND

An online auction is an auction that is typically held over the Internet. Online auctions have greatly increased the variety of goods and services that can be bought and sold using various auction mechanisms. In the current web environment, various websites provide online auction practices. For example, a travel website provides a vacation package for sale or for bidding in an online auction. The vacation package includes, but is not limited to one or more of a hotel reservation, a cruise reservation, an event ticket, an airline ticket, a car rental, and a tourist attraction ticket. The travel website that offers the vacation package in an online auction allows a plurality of bidding users to provide a bid price for the vacation package. In a typical online auction, the bidding user that proposes the highest bid price wins the auction and has the opportunity to purchase the vacation package. However, this does not allow other bidding users that do not win the online auction to buy the vacation package.

### SUMMARY

A system and method for online bidding is disclosed. According to one embodiment, a computer-implemented method by a server includes receiving an available number of units of an offered item for bidding in an online auction from one of an inventory provider and a database, receiving a first bid price for the offered item from a first user account on a first user device, providing an indication to the first user account to purchase a first unit at the first bid price, determining a remaining number of units from the available number of units, receiving a second bid price for the offered item from a second user account on a second user device, and providing an indication to the second user account to purchase a second unit at the second bid price based on the second bid price greater than the first bid price by at least a minimum bid step, and based on the remaining number of units.

The above and other preferred features, including various novel details of implementation and combination of elements, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments.

### BRIEF DESCRIPTION OF THE FIGURES

The accompanying figures, which are included as part of the present specification, illustrate the various embodiments of the present disclosed system and method and together with the general description given above and the detailed description of the preferred embodiments given below serve to explain and the teach the principles of the present disclosure.

FIG. 1 illustrates an exemplary online bidding and sales system, according to one embodiment.

FIG. 2 illustrates an exemplary flow chart for online bidding, according to one embodiment.

FIG. 3 illustrates an exemplary flow chart for providing multiple sales of an available number of units of an offered item, according to one embodiment.

FIG. 4 illustrates an exemplary diagram of an online bidding user interface, according to one embodiment.

FIG. 5 illustrates an exemplary flow chart for bidding with a bid roof in an online auction, according to one embodiment.

FIG. 6 illustrates an exemplary computer architecture that may be used for the present system, according to one embodiment;

It should be noted that the figures are not necessarily drawn to scale and elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

A system and method for online bidding is disclosed. According to one embodiment, a computer-implemented method by a server includes receiving an available number of units of an offered item for bidding in an online auction from one of an inventory provider and a database, receiving a first bid price for the offered item from a first user account on a first user device, providing an indication to the first user account to purchase a first unit at the first bid price, determining a remaining number of units from the available number of units, receiving a second bid price for the offered item from a second user account on a second user device, and providing an indication to the second user account to purchase a second unit at the second bid price based on the second bid price greater than the first bid price by at least a minimum bid step, and based on the remaining number of units.

Each of the features and teachings disclosed herein can be utilized separately or in conjunction with other features and teachings to provide a system and method for online bidding. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

According to one embodiment, the present system includes a widget that can be installed and executed within a website that is hosted by the present system or a partner website. The present system allows a partner website to publish the widget on the partner website. The widget provides a real-time status (e.g., a current bid price and a counter clock) of an offered item for bidding as hosted by the present system. A user may bid for the offered item by accessing the website hosted by the present system through the widget, or by bidding directly using the widget on the partner website. The offered item includes, but is not limited to, a hotel reservation, a cruise reservation, an event ticket, an airline ticket, a car rental, and a tourist attraction ticket.

According to one embodiment, the present widget includes information related to the offered item, including, but not limited to, an image of the offered item, a current bid price if the offered item is in an online auction, a purchase price if the offered item is available for direct sale (or direct purchase), a counter clock, a title and a subtitle of the offered item, and a link to the website hosted by the present system. The present widget may include multiple offered items, in one embodiment. The present widget provides a link to the website hosted by the present system in hypertext markup language (HTML) format, in another embodiment. The offered item may be available for direct sale in addition to being offered for auction or instead of being offered for auction.

According to one embodiment, the present system provides integration with an external inventory provider (e.g., a global distribution system (GDS) and a computer reservation system (CRS)) to store this information. A GDS enables an automated transaction between a third-party provider (e.g., an airline, a hotel, and a car rental company) and a booking agent in order to provision travel related services to a user. A CRS is a computerized system for saving and retrieving information related to leisure and travel. The present system caches static content (e.g., an image of an offered item, a description, an attribute, and an additional service) on the database and connects to the external inventory provider with a request using hypertext transfer protocol (HTTP) and communicates with the external inventory provider using various output data formats (e.g., extensible markup language (XML), javascript object notation (JSON), and comma-separated values (CSV)).

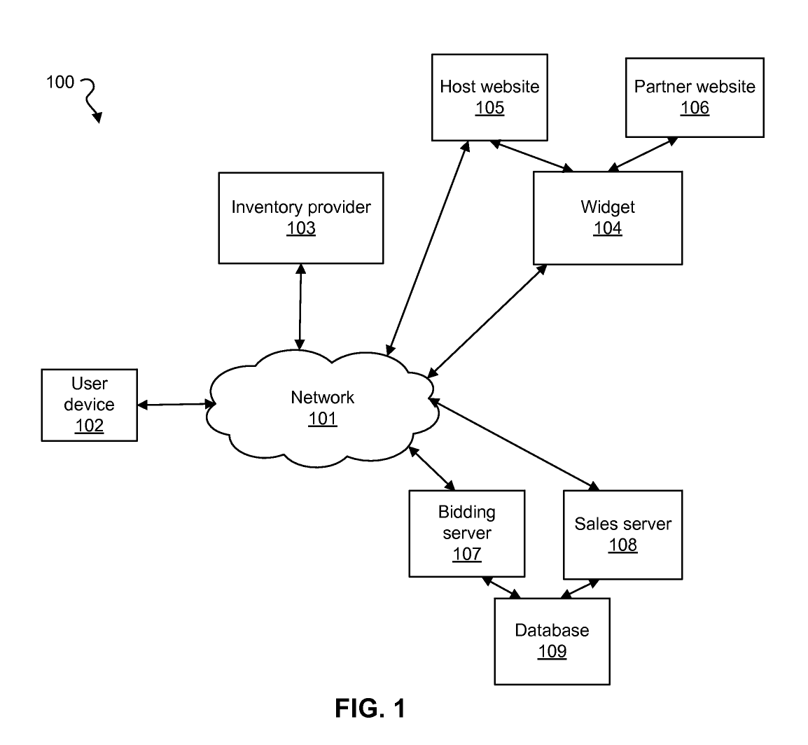

FIG. 1 illustrates an exemplary online bidding and sales system, according to one embodiment. The present system 100 includes a network 101 that provides communication between a user device 102, a bidding server 107, a sales server 108, and a widget 104. The user device 102 may be any form of computing device including, but not limited to, a mobile phone, a tablet, a desktop computer, and a laptop.

The user device 102 accesses a widget 104 on a host website 105 or a partner website via the network 101. The widget 104 provides an interface that allows a user on the user device 102 to provide an online bid or a purchase of an offered item. The widget provides information related to the offered item, including, but not limited to, an image of the offered item, a current bid price if the offered item is in an online auction, a purchase price if the offered item is available for sale, a counter clock, a title and a subtitle of the offered item. According to one embodiment, the offered item includes, but is not limited to, one or more of a hotel reservation, a cruise reservation, an event ticket, an airline ticket, a car rental, and a tourist attraction ticket. The user device 102 may access the host website to provide an online bid or a purchase of the offered item, according to one embodiment. The present system allows the user device 102 to provide a bid price or a purchase price using multiple types of currencies, according to one embodiment.

According to one embodiment, the bidding server 107 provides the widget 104 and/or the host website 105 via the network 101 to provide an offered item in an online auction. The widget 104 and/or the host website 105 receive user information, a bid price, and a desired offered item from the user device 102 via the network 101 when the online auction is active. According to one embodiment, the sales server 108 provides the widget 104 and/or the host website 105 via the network 101 to provide an offered item for sale. The widget receives user information and a desired offered item from the user device 102 via the network 101.

The bidding server 107 and the sales server 108 include an application programming interface (API) for communicating between the user device 102 and a database 109. The API provides a management module to manage data, including creating, viewing, editing, and deleting data such as a notification to a user (e.g., an administrator), a widget, an auction, an offer, an availability, a collection a frequently-asked-question, a hotel, a notification, a booking, a partner, a direct payment, a text file, a discount, a proposed bidding price, a notification push, a programmed task, a payment transaction, a translation, and a user account.

The API further provides a scheduled task module to launch a configured task at a desired time, For example, the scheduled task module begins and ends an online auction at specified times. In another example, the scheduled task module provides maintenance and indexes an offered item and/or an online auction at the database, determines search data, and calculates a price (e.g., a minimum price of the day). The scheduled task module further manages a task related to a dashboard module on a user interface (explained below), and provides statistical data. The scheduled task module further provides a self-scheduling auction.

The API further provides a secure connection between the user device 102 and the bidding server 107 and/or the sales server 108 during an online auction. The API further manages notifications including sending emails and provides a newsletter service (e.g., a weekly newsletter).

According to one embodiment, the bidding server 107 and the sales server 108 communicate with an external inventory provider 103 (e.g., a GDS and a CRS) via the network 101 to access information regarding an offered item. For example, the bidding server 107 and the sales server 108 receive offered item information, such as an image, a description, an attribute, and an available number of units of the offered item. The bidding server 107 and the sales server 108 store the offered item information in the database 109. The bidding server 107 and the sales server 108 may further communicate with the external inventory provider 103 to enable an automated sale of the offered item.

According to one embodiment, the bidding server 107 and the sales server 108 sends an email to the external inventory provider 103 that includes sales information of the offered item. The email includes, but is not limited to, a booking code, booking details such as a name, a contact number, an email address, a check-in date, a quantity of the offered item, and a description of the offered item.

According to one embodiment, the database 109 stores information regarding the offered item, including, but not limited to, a content of the offered item (e.g., a description and an image), an availability of the offered item (including a calendar, if required), a starting price, a minimum bid step, a currency and other measurement systems to value the offered item, a purchase price if the offered item is available for direct sale (or direct purchase), a counter clock, a title and a subtitle of the offered item, a list of bid prices and a bid roof (i.e., a maximum pay amount that a user is willing to pay), information related to the offered item (e.g., an additional service and an additional item included with the offered item), and geolocalization of the offered item. The database may include a general database (e.g., MONGODB®) for storing all the data, an auxiliary database (e.g., REDIS™) for storing a session data of a user, and an auxiliary database (e.g., ELASTICSEARCH™) for caching information related to a user search, an availability of an online auction, and related data regarding the online auction in order to perform real-time searches. The present system may be based on a cloud computing platform (e.g., AMAZON WEB SERVICES™), according to one embodiment.

According to one embodiment, the present system provides an online auction for an available number of units of an offered item. For example, the present system provides 10 tickets for an offered item that is a concert ticket. In another example, the present system provides 5 units representing 5 hotel reservations for an offered item that is a 7-night hotel reservation in Barcelona. The 5 units for the 7-night hotel reservation may be for the same or different starting dates. The present system allows a user to access a calendar that shows available starting dates for the available number of units of the offered item. The calendar is dynamic and varies based on a booking of an available unit of the offered item. The present system provides a minimum bid step that is a minimum amount that a user must bid above a current highest bid price. The present system only accepts a bid price from a user that is above the current highest bid price by at least the minimum bid step. For example, if the minimum bid step is $5 and the current highest bid price is $40, the present system only accepts a bid price that is at least $45 or greater than $5. The present system allows a sale of a unit of an offered item at each proposed bid price provided by each user, subject to an available number of units of the offered item. The present system allows a user to purchase a unit of an offered item at the user's bid price in real time. When the user purchases a unit of the offered item, the present system allows the user to select an available starting date for the offered item.

The present system invites a user to register and create a user account with the present system before receiving a bid price from the user. According to one embodiment, the present system allows the user to register using a user account from a social media network (e.g., FACEBOOK® and TWITTER®). The present system receives user information of the user (e.g., an email address and a name) from the social media network and creates a user account in a database with the user information. The present system also stores a social media network identifier together with the user account in the database. According to another embodiment, the present system allows the user to register using user information including, but limited to, a name, an email address, and a password. The present system creates a user account in the database with the user information. The present system may further send an email to the user that includes a verification link. When the user selects the verification link, the present system directs the user to the host website and logs the user into the host website. The present system allows the user to log into the host website by receiving a user identifier (ID) and a password and authenticates the user based on a cookie. The host website transmits the user ID to the API where the API checks the user ID and password and provides an encrypted cookie with the encrypted user ID based on a java script objection notation (JSON) web token (JWT). The API provides the cookie each time the user logs in to authenticate the user.

When a first user provides a first bid price for the offered item, the present system provides an indication to the first user that he/she has won a bid for the offered item and may purchase a first unit of the offered item at the first bid price. The bid price at which a user wins an online bid for the offered item may be referred to as a winning bid price. According to one embodiment, the present system does not allow the first user to provide a bid price for other offered items unless he/she purchases the first unit of the offered item at the first bid price. The present system indicates a change in a status of the first user to show that the first user has not paid the first bid price. The present system further receives a subsequent bid price from a subsequent user that is greater than the previous winning bid price by at least the minimum bid step. The present system provides an indication to the subsequent user that he/she has won a bid for the offered item and may purchase a subsequent unit of the offered item at the subsequent bid price. The present system repeats this process until the remaining available number of units of the offered item have been awarded to one or more subsequent users that provide a bid price that is greater than the previous winning bid price by at least the minimum bid step. According to one embodiment, the present system does not allow a subsequent user to provide a bid price for other offered items unless he/she purchased a subsequent unit of the offered item at the subsequent bid price. This gives a sense of urgency for limited or scarce desirable items. According to one embodiment, the present system does not allow a user to know the number of available units of the offered item left for bidding in the online auction. In another embodiment, the present system allows the user to know the number of available units of the offered item left for bidding in the online auction.

According to one embodiment, the present system further receives reservation information (e.g., a date and passport information) and payment information (e.g., credit card information and an address) from each of the various users to complete the respective sale of the respective unit of the offered item at the respective winning bid price.

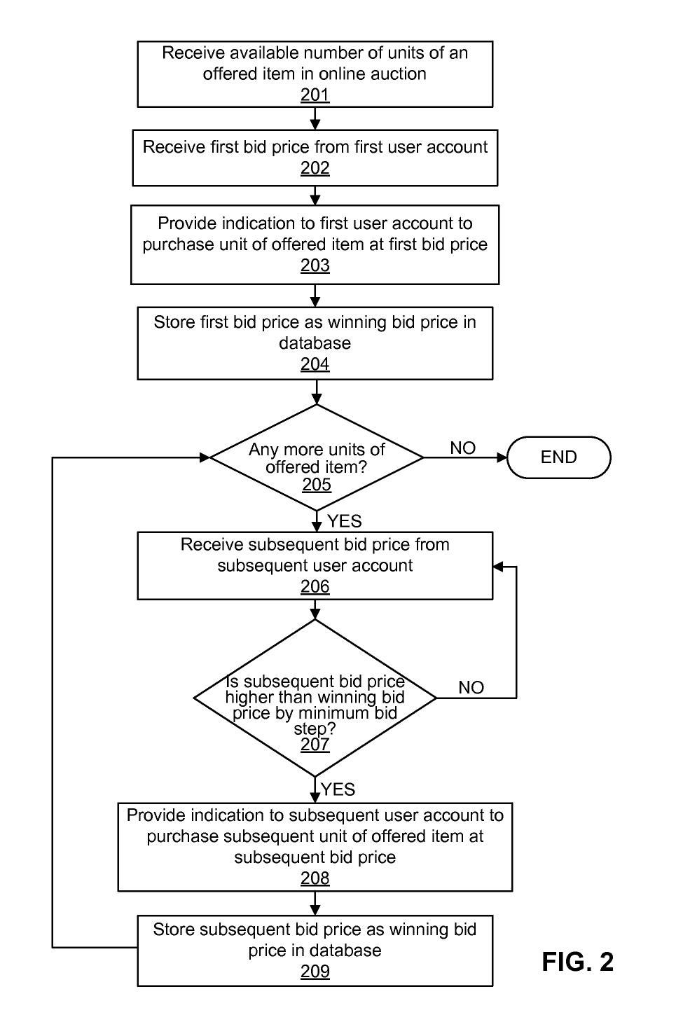

FIG. 2 illustrates an exemplary flow chart for online bidding, according to one embodiment. The present system receives an available number of units of an offered item for bidding in an online auction from an inventory provider at 201. The present system receives a first bid price from a first user account at 202. The present system provides an indication to the first user account to purchase a unit of the offered item at 203. For example, the present system informs the first user account that the first user account has won the online auction and may purchase a unit of the offered item at the first bid price. The present system stores the first bid price as a winning bid price in a database at 204. The present system determines whether there are remaining units of the offered item for bidding in the online auction at 205. According to one embodiment, the present system determines an availability of units of the offered item through integration with an external inventory provider (e.g., GDS and CRS) or a database. If there are no more units of the offered item that are available for bidding, the process ends. If there are one or more remaining units of the offered item that are available for bidding, the present system receives a subsequent bid price from a subsequent user account at 206. The present system determines whether the subsequent bid price is greater than the winning bid price by at least a minimum bid step at 207. According to one embodiment, the present system receives a user-configured minimum bid step. If the subsequent bid price is not greater than the winning bid price by at least the minimum bid step, the present system repeats to receive a subsequent bid price from a subsequent user account at 206. If the subsequent bid price is greater than the winning bid price by at least the minimum bid step, the present system provides an indication to the subsequent user account to purchase a subsequent unit of the offered item at the subsequent bid price at 208. For example, the present system informs the subsequent user account that the subsequent user account has won the online auction and may purchase a unit of the offered item at the subsequent bid price. The present system stores the subsequent bid price as the winning bid price in the database at 209. The present system repeats the process from 205 through 209 until the present system determines that there are no more units of the offered item available for bidding in the online auction.

According to one embodiment, the present system allows multiple sales for an available number of units of an offered item, each at a different incremental price. The present system allocates an available number of units of an offered item. The present system sets a first bid price of a first sale of a first unit of an offered item as a starting price. The present system subsequently performs a second sale of a second unit of the offered item at a price that is incremented with a minimum bid step from the previous bid price, until the available number of units of the offered item is awarded. In one embodiment, the present system determines the minimum bid step when the item is first offered for sale.

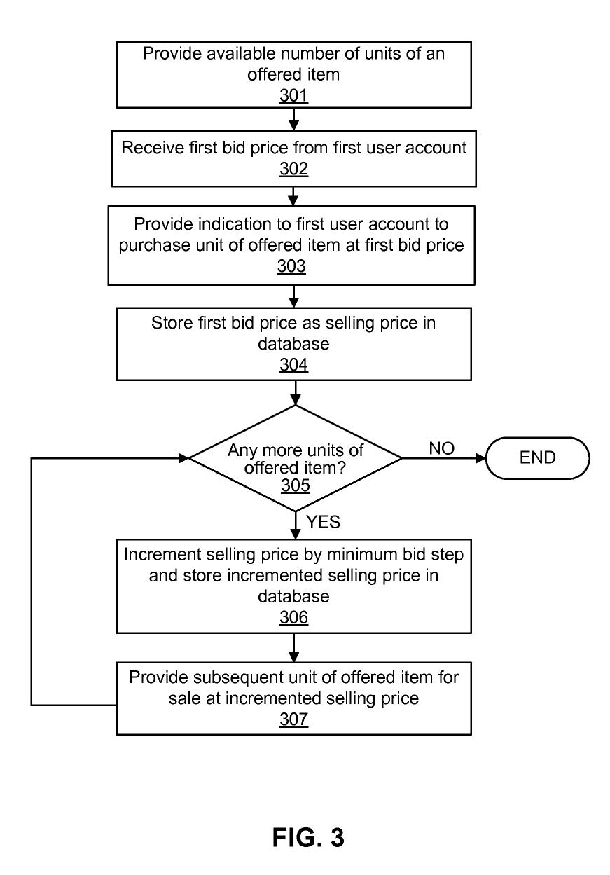

FIG. 3 illustrates an exemplary flow chart for providing multiple sales of an available number of units of an offered item, according to one embodiment. The present system provides an available number of units of an offered item at 301. The present system receives a first bid price from a first user account at 302. The present system provides an indication to the first user account to purchase a unit of the offered item at the first bid price at 303. For example, the present system informs the first user account that the first user account has won the online auction and may purchase a unit of the offered item at the first bid price. The present system stores the first bid price as a selling price in a database at 304. The present system determines whether there are remaining units of the offered item for sale at 305. If there are no more units of the offered item that are available for sale, the process ends. If there are one or more remaining units of the offered item that are available for sale, the present system increments the selling price by a minimum bid step and stores the incremented selling price in the database at 306. The present system provides a subsequent unit of the offered item for sale at the incremented selling price at 307. The present system repeats the process from 305 through 307 until the present system determines that there are no more units of the offered item that are available for sale.

According to one embodiment, the present system provides a sale of an item when a user provides his/her requirement information (e.g., a location, a date, and other requirements) and a bid roof, i.e., a maximum amount that he/she is willing to pay. The present system sources a best offer price that is within the bid roof, and provides such offer price to the user.

According to one embodiment, the present system allows a user to have access to an offered item within a specific pricing. The present system receives requirement information (e.g., a location and a date) from a user during a search and provides a list of results that satisfies the user's requirement information. If the present system receives additional information regarding the user's maximum willingness to pay (i.e., the user's bid roof), the present system further provides a requested offered item that satisfies the user's requirement information and an offer price that is within the user's bid roof. According to one embodiment, details regarding the offered item (e.g. a name of a hotel if the offered item is related to a hotel reservation) can be disclosed either before or after the purchase of the offered item.

According to one embodiment, the present system searches for a price of an upgraded item compared to the requested offered item that is within a pre-determined range (e.g., 20% greater than the maximum pay amount that the user is willing to pay). If the price of the upgraded item compared to the offered item is within the pre-determined range, the present system further proposes the upgraded item to the user. According to one embodiment, the present system may offer the upgraded item to the user before or after the user completes the purchase of the offered item.

According to one embodiment, the present system provides a user interface to the host website on a user device. The user interface is based on a PHP framework (e.g., SYMFONY2™), according to one embodiment. The user interface includes, but is not limited to, a hotel toolbar module, an experience toolbar module, an online auction module, an offer module, a hotel module, a collection module, a user configuration module, and a user notification module. The hotel toolbar module provides a search for one or more hotels in the database based one or more of a location, a check-in date, and a check-out date. The experience toolbar module provides a search of a catalogue of actions, a direct booking, a location, and a date. The online auction module allows a user to access one or more online auctions. The offer module allows a user to configure a direct booking for an offered item based on a calendar. The hotel module allows a user to configure a direct booking for a hotel. The present system accesses an external inventory provider to provide a hotel for direct booking. The collection module provides a cluster of auction bids or hotels with related keywords for example, a location, an event, a time, and a category. The user configuration module allows a user to configure user information such as credit card information, a language preference, and view/manage his/her reservations. The user notification module allows a user to view a desired auction and/or desired offer.

According to one embodiment, the present system provides a user interface that provides access to a user (e.g., an administrator) to manage the host website including receiving an event, viewing statistical data, and editing and publishing an offer. According to one embodiment, the user interface is based on a PHP framework (e.g., SYMFONY2™), that connects to an API service (e.g., NODEJS ™) on the bidding server and/or sales server. The user interface accessible to an administrator includes, but is not limited to, a dashboard module, a user management module, a partner management module, an auction management module, an offer management module, a sales management module, an affiliate management module, a hotel management module, and a content management module.

The dashboard module provides website information such as a number of users, a booking, and an event provided on the host website. The user management module allows an administrator to access and edit a list of users. The partner management module allows an administrator to access and edit a list of partner websites.

The auction management module allows an administrator to access and edit a list of auctions. The auction management module further allows an administrator to schedule an online auction and manage an availability calendar for an offered item in the online auction.

The sales management module allows an administrator to access and edit a list of bookings, create a specific payment transaction link (e.g., a specific uniform resource locator (URL)) associated with a user account, propose a desired price for an offered item and/or an online auction associated with a user account. A user with the user account may accept the proposed price for the offered item and purchase the offered item. The sales management module further allows an administrator to create a desired discount (e.g., a discount code) based on specific criteria. The affiliate management module allows an administrator to manage an affiliate and generate a private label to sell an offered item and/or an online auction.

The hotel management module allows an administrator to access, edit, and/or disable a desired hotel on the host website. The content management module allows an administrator to access and edit a desired language for the host website, manage frequently-asked-questions, edit a collection, an online auction, and an offered item, manage a widget including creating a widget for an offered item and/or online auction.

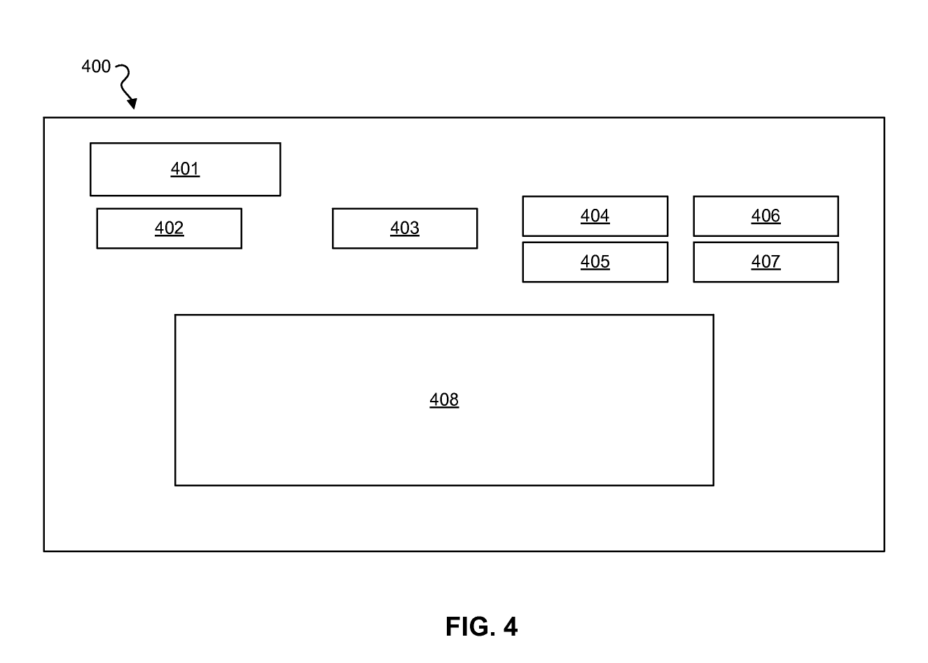

FIG. 4 illustrates an exemplary diagram of an online bidding user interface, according to one embodiment. A user interface 400 displays a title 401 of an offered item available for bidding in an online auction. The user interface 400 includes offered item information 408 that includes, but is not limited to, an image, a slideshow, a description, a time to complete a reservation, a map, minimum bid step information, and a bid history. The bid history includes a list of users and their respective bid prices.

The user interface 400 provides a counter clock display 402 that illustrates a time period remaining before the online auction expires. The user interface 400 further includes a bid price display 403 that provides a starting price of the offered item or a current highest bid price. The bid price display 403 may be viewed only by a user who has registered a user account and logged in to the present system, according to one embodiment.

The user interface 400 includes a minimum bid step 405 that includes a minimum amount that a user has to bid over a current highest bid price. The user interface 400 allows a user to enter a bid price for the offered item in a bid price configuration 404. The user interface 400 includes a bid button 406 that may be selected by a user to input the bid price entered in the bid price configuration 404 as a desired bid price for the offered item. If the user selects the bid button 406 with a bid price in the bid price configuration 404 that is lower than the current highest bid price or not greater than the current highest bid price by at least the minimum bid step 405, the present system prompts the user on the user interface 400 with an error message. The error message informs the user to provide a new bid price for the offered item. The user interface 400 further includes a bid roof button 407 that may be selected by the user to input the bid price entered in the bid price configuration 404 as a bid roof. The bid roof is a maximum bid price that the user is willing to bid for the offered item.

According to one embodiment, the present system sets a first bid price for a first user that is greater than a current highest bid price shown in the bid price display 403 by the minimum bid step 405. If a second user provides a second bid price that is greater than the first bid price by at least the minimum bid step, the present system automatically increases the first bid price by the minimum bid step 405 greater than the second bid price. The present system repeats increasing the first bid price if a subsequent user provides a subsequent bid price that is greater than the current highest bid price by at least the maximum bid step 405 until the first bid price reaches the maximum bid price. If the second user provides a second bid price that is greater than the maximum bid price, the present system notifies the first user. For example, if the first user configures an option on his/her profile to receive a notification from the present system in the form of an email, the present system notifies the first user by sending an email to the first user.

For example, the user interface 400 displays $30 as a current highest bid price for an offered item in the bid price display 403. The user interface 400 further displays the minimum bid step 405 as $1. User A may enter $31 in the bid price configuration 407 to set $31 as his/her desired bid price for the offered item. Alternatively, user A may enter $50 in the bid price configuration 404 and select the bid roof button 407 to set $50 as his/her bid roof. The present system sets user A's bid price as $31 and displays user A's bid price of $31 as the current highest bid price in the bid price display 403.

User B enters $32 in the bid price configuration 407 as his/her desired bid price for the offered item. The present system assigns user B's bid price of $32 as the current highest bid price. The present system automatically increases user A's bid price to $33 by adding the minimum bid step of $1 to the current highest bid price of $32. The present system displays user A's bid price of $33 in the bid price display 403.

User C enters $36 in the bid price configuration 407 as his/her desired bid price for the offered item. The present system assigns user C's bid price of $36 as the current highest bid price. The present system automatically increases user A's bid price to $37 by adding the minimum bid step of $1 to the current highest bid price of $36. The present system displays user A's bid price of $37 in the bid price display 403. The present system continues process of increasing user A's bid price if another user's bid price exceeds user A's current bid price until the bid roof is reached. For example, if user D enters $51 in the bid price configuration 407 as his/her desired bid price for the offered item, the present system notifies user A that user A's bid roof has been exceeded.

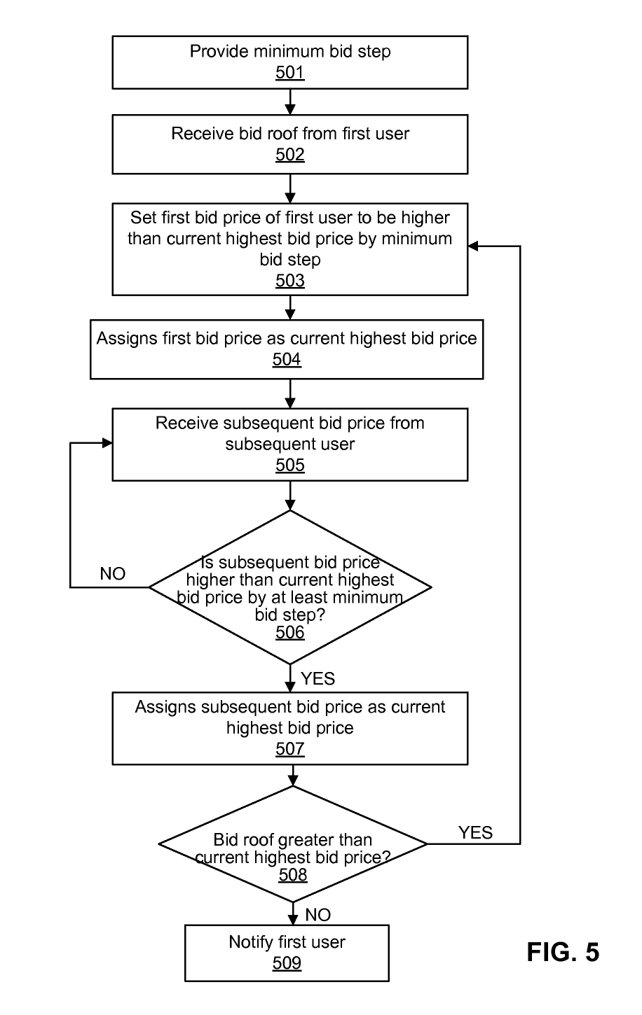

FIG. 5 illustrates an exemplary flow chart for bidding with a bid roof in an online auction, according to one embodiment. The present system provides a minimum bid step that is a minimum amount to bid over a current highest bid price for an offered item at 501. The present system receives a bid roof from a first user at 502. The bid roof is a maximum bid price that the first user is willing to bid for the offered item. The present system sets a first bid price of the first user to be greater than a current highest bid price by the minimum bid step at 503. The present system assigns the first bid price as the current highest bid price at 504. The present system receives a subsequent bid price from a subsequent user at 505. The present system determines whether the subsequent bid price is greater than the current highest bid price by at least the minimum bid step at 506. If the subsequent bid price is not greater than the current highest bid price by at least the minimum bid step, the present system returns to receive a subsequent bid price from a subsequent user. If the subsequent bid price is greater than the current highest bid price by at least the minimum bid step, the present system assigns the subsequent bid price as the current highest bid price at 507.

The present system further determines whether the bid roof of the first user is greater than the current highest price at 508. If the bid roof of the first user is lower than the current highest price, the present system notifies the first user at 509. For example, the present system sends an email to the first user to notify him/her that the current highest bid price has exceeded the bid roof. If the bid roof of the first user is greater than the current highest price, the present system returns to set the first bid price to be greater than the current highest bid price by the minimum bid step at 503.

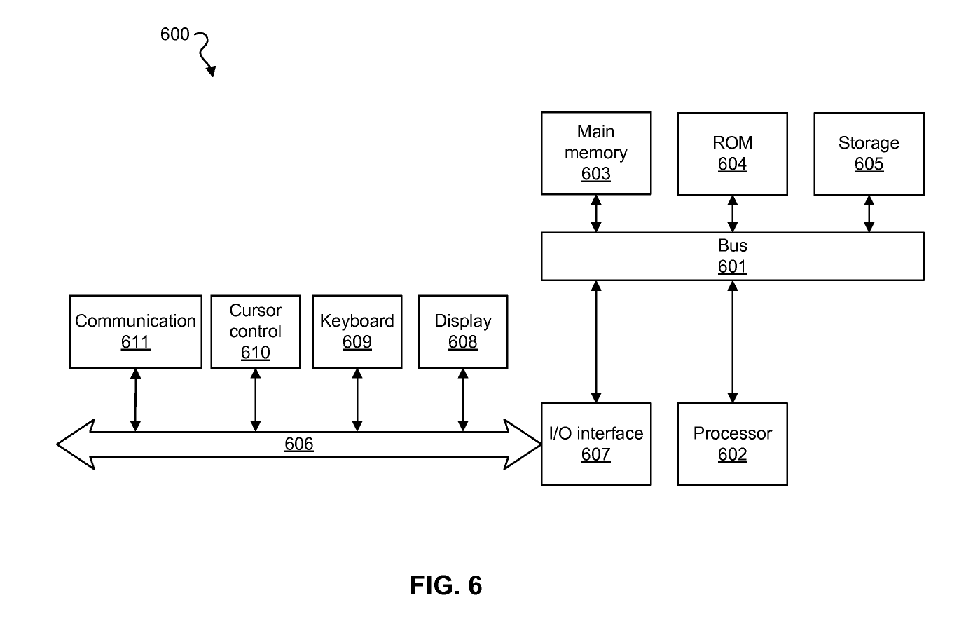

FIG. 6 illustrates an exemplary computer architecture that may be used for the present system, according to one embodiment. The exemplary computer architecture may be used for implementing one or more components described in the present disclosure including, but not limited to, the present system. One embodiment of architecture 600 includes a system bus 601 for communicating information, and a processor 602 coupled to bus 601 for processing information. Architecture 600 further includes a random access memory (RAM) or other dynamic storage device 603 (referred to herein as main memory), coupled to bus 601 for storing information and instructions to be executed by processor 602. Main memory 603 also may be used for storing temporary variables or other intermediate information during execution of instructions by processor 602. Architecture 600 may also include a read only memory (ROM) and/or other static storage device 604 coupled to bus 601 for storing static information and instructions used by processor 602.

A data storage device 605 such as a magnetic disk or optical disc and its corresponding drive may also be coupled to architecture 600 for storing information and instructions. Architecture 600 can also be coupled to a second I/O bus 606 via an I/O interface 607. A plurality of I/O devices may be coupled to I/O bus 606, including a display device 608, an input device (e.g., an alphanumeric input device 609 and/or a cursor control device 610).

The communication device 611 allows for access to other computers (e.g., servers or clients) via a network. The communication device 611 may include one or more modems, network interface cards, wireless network interfaces or other interface devices, such as those used for coupling to Ethernet, token ring, or other types of networks.

The above example embodiments have been described hereinabove to illustrate various embodiments of implementing a system and method for online bidding. Various modifications and departures from the disclosed example embodiments will occur to those having ordinary skill in the art. The subject matter that is intended to be within the scope of the disclosure is set forth in the following claims.

We claim:

1. A computer-implemented method, comprising:
receiving, by a server, an available number of units of an offered item for bidding in an online auction from one of an inventory provider and a database;
receiving, by the server, a first bid price for the offered item from a first user account on a first user device;
providing, by the server, an indication to the first user account to purchase a first unit of the offered item at the first bid price;
determining, by the server, a remaining number of units from the available number of units of the offered item;
receiving, by the server, a second bid price for the offered item from a second user account on a second user device; and
providing, by the server, an indication to the second user account to purchase a second unit of the offered item at the second bid price based on the second bid price greater than the first bid price by at least a minimum bid step, and based on the remaining number of units of the offered item.

2. The computer-implemented method of claim 1, wherein the offered item includes one or more of a hotel reservation, a cruise reservation, an event ticket, an airline ticket, a car rental, and a tourist attraction ticket.

3. The computer-implemented method of claim 1, further comprising providing, by the server, a sale of the first unit of the offered item from the inventory provider to the first user account.

4. The computer-implemented method of claim 3, further comprising receiving, by the server, one or more of reservation information and payment information to complete the sale of the first unit of the offered item.

5. The computer-implemented method of claim 4, wherein the reservation information includes one or more of a reservation date and passport information, and wherein the payment information includes one or more of credit card information and an address.

6. The computer-implemented method of claim 1, further comprising receiving, by the server, a bid roof from a third user account, wherein the bid roof indicates a maximum bid price for the offered item.

7. The computer-implemented method of claim 6, further comprising assigning, by the server, a third bid price of the third user account to be greater than the second bid price by the minimum bid step based on the bid roof being greater than the second bid price.

8. The computer-implemented method of claim 7, further comprising storing, by the server, one or more of the first bid price, the second bid price, and the third bid price in the database.

9. The computer-implemented method of claim 1, further comprising receiving, by the server, user requirement information and a bid roof from one or more of the first user account and the second user account, wherein the bid roof includes a maximum desired price for the offered item, and wherein the user requirement information includes one or more of a location and a date.

10. The computer-implemented method of claim 9, further comprising:
determining, by the server, a price of an upgraded item that is within a pre-determined range greater than the bid roof; and
providing, by the server, the upgraded item to one or more of the first user account and the second user account.

11. A non-transitory computer readable medium having stored thereon computer-readable instructions, and a processor coupled to the non-transitory computer readable medium, wherein the processor executes the instructions to:
receive an available number of units of an offered item for bidding in an online auction from one of an inventory provider and a database;
receive a first bid price for the offered item from a first user account on a first user device;
provide an indication to the first user account to purchase a first unit of the offered item at the first bid price;
determine a remaining number of units from the available number of units of the offered item;
receive a second bid price for the offered item from a second user account on a second user device; and
provide an indication to the second user account to purchase a second unit of the offered item at the second bid price based on the second bid price greater than the first bid price by at least a minimum bid step, and based on the remaining number of units of the offered item.

12. The non-transitory computer readable medium of claim 11, wherein the offered item includes one or more of a hotel reservation, a cruise reservation, an event ticket, an airline ticket, a car rental, and a tourist attraction ticket.

13. The non-transitory computer readable medium of claim 11, wherein the processor provides a sale of the first unit of the offered item from the inventory provider to the first user account.

14. The non-transitory computer readable medium of claim 13, wherein the processor receives one or more of reservation information and payment information to complete the sale of the first unit of the offered item.

15. The non-transitory computer readable medium of claim 14, wherein the reservation information includes one or more of a reservation date and passport information, and wherein the payment information includes one or more of credit card information and an address.

16. The non-transitory computer readable medium of claim 11, wherein the processor receives a bid roof from a third user account, wherein the bid roof indicates a maximum bid price for the offered item.

17. The non-transitory computer readable medium of claim 16, wherein the processor assigns a third bid price of the third user account to be greater than the second bid price by the minimum bid step based on the bid roof being greater than the second bid price.

18. The non-transitory computer readable medium of claim 17, wherein the processor stores one or more of the first bid price, the second bid price, and the third bid price in the database.

19. The non-transitory computer readable medium of claim 11, wherein the processor receives user requirement information and a bid roof from one or more of the first user account and the second user account, wherein the bid roof includes a maximum desired price for the offered item, and wherein the user requirement information includes one or more of a location and a date.

20. The non-transitory computer readable medium of claim 19, wherein the processor determines a price of an upgraded item that is within a pre-determined range greater than the bid roof, and provides the upgraded item to one or more of the first user account and the second user account.
